(19) United States
(12) Patent Application Publication
(10) Pub. No.: US 2010/0251260 A1
(43) Pub. Date: Sep. 30, 2010

(54) PRE-EMPTIBLE CONTEXT SWITCHING IN A COMPUTING DEVICE

(75) Inventor: Dennis May, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 12/063,183

(22) PCT Filed: Aug. 8, 2006
(86) PCT No.: PCT/GB2006/002973

§ 371 Date: Jun. 15, 2010

(30) Foreign Application Priority Data
Aug. 10, 2005 (GB) 0516474.4

(51) Int. Cl. G06F 9/46

(52) U.S. Cl. 718/108

(57) ABSTRACT

Context switching between threads belonging to different user-side processes is a time consuming procedure because of the need to move a potentially large number of memory mappings around and the need to flush the data cache on hardware architectures which utilise a virtually tagged data cache. This invention allows the modification of page directory entries and the flushing of the data cache during a context switch to occur with pre-emption enabled; if a third process needs to run during a context switch, and this third process doesn't own or require any user memory modification of the page tables, this is now possible. By means of this invention, switches to kernel threads and threads in fixed user processes can occur much faster; these threads don't belong to processes that own any user memory and are the very ones that need to run with a lower guaranteed latency to ensure real-time performance.

This invention relates to improving the performance, responsiveness and efficiency of multitasking computing devices, and in particular, to the provision of such improvements through the use of pre-emptible context switching.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device mentioned above, together with many other forms of industrial and domestic electronic appliances which rely upon software for their functionality.

Most advanced computing devices are controlled by an operating system (OS), which controls the overall operation of the device. Within the OS, the kernel represents the central core, having a very high degree of control over all the rest of the hardware and software in the device; typically, the kernel runs in a privileged supervisor mode whereby it is trusted to do things that ordinary applications (which run in user mode) are not trusted to do.

A multitasking computing device can rapidly switch between the execution of any one of a number of separate series of instructions, with each coherent series being termed a thread. The thread is regarded, therefore, as the unit of execution on such a device. Switching between threads is termed a context switch.

The memory on computing devices is partitioned among varying processes, with each process consisting of one or more threads. Where a process consists of more than one thread, all the threads in that process have access to the same shared memory; but a thread in one process cannot access the memory of any process other than its own process. The process can be regarded, therefore, as the unit of memory protection on a device.

It follows from this that when a computing device switches between a first thread in a first process and a second thread in a second process, the transfer of execution from the first thread to the second thread must also be accompanied by some form of switch in the active memory in use from that owned by the first process to that owned by the second process.

One of the most common schemes for achieving this makes use of the fact that the memory on modern computing devices is usually under very tight management, typically under the control of the kernel. Those skilled in the art will be aware that memory on a device is grouped into pages of contiguous addresses, and that the totality of all the possible addressable memory locations on the device is termed virtual memory addresses. The totality of the addresses of the memory that actually is installed are termed physical memory addresses and computing devices contain a mapping of virtual memory pages addresses to physical memory page addresses maintained by a memory management unit or MMU. By altering the contents of the page directory entries holding this mapping, a set of virtual memory addresses can be made to point at any desired area of addressable physical memory. A context switch between threads in different processes is, in a scheme as set out above, accompanied by a remapping of memory so as to protect the memory of the process whose thread has been switched out and to make accessible the memory of the process whose thread has been switched in.

In order to speed up accesses to relatively slow main memory, computing devices often take advantage of the phenomenon of locality, the study of which stretches back over three decades. Locality is
“the phenomenon that memory references tend to be clustered in small memory areas during the execution of a program” (from “Ordering functions for improving memory reference locality in a shared memory multiprocessor system” by Youfeng Wu in Proceedings of the 25th annual international symposium on Microarchitecture table of contents, 1992)

Computing devices therefore maintain a cache, which consists of a small amount of much faster memory that holds the contents of the last pages of memory that have been read. Where a request to read memory references a page that has been tagged as being in the cache, a cache hit is said to occur, and the memory can be accessed from the faster cache memory rather than the relatively slow main memory.

However, it is common on many computing devices for the memory addresses used for the cache to be virtual memory addresses rather than physical ones. This means that when a context switch occurs between threads in different processes, the logic behind the workings of the cache are rendered invalid, and reading data from the cache because the requested memory access happens to match a virtual address that is held will almost certainly be a wrong thing to do. Consequently, such a context switch needs to invalidate the entire contents of the cache so that any access to virtual memory addresses previously held in the cache will result in a cache miss, forcing a read from physical memory.

Such an invalidation of cache contents is called flushing the cache. All of the above operations will be familiar to the person skilled in this art.

It can be seen from the above description that a context switch between threads belonging to different user-side processes can be a time consuming procedure owing to the need to move a potentially large number of memory mappings around and to the need to flush the data cache on hardware architectures which utilise a virtually tagged data cache. During this time, the device is typically non-responsive, because these operations are typically run with pre-emption disabled; this means that a context switch between two processes is not allowed to be pre-empted by a third process that is ready to run.

The length of the time taken to perform a context switch has been measured on ARM architecture 4 and 5 processors. This can involve, in the worst case, the following actions:
Modification of page directory entries to move the virtual addresses of all the memory attached to the previous process
Protecting all memory attached to the previous process
Modification of page directory entries to move the virtual addresses of all memory attached to the new process
Flushing the processor data cache.

On processors with large data caches and slow memory interfaces, this could take more than 500 μs, which in computing terms is a relatively large delay. This is a measured value from one such system. If all this work were to be carried out directly by the scheduler of the computing device, with preemption disabled, this would add half a millisecond or more to the worst case thread latency (the maximum time it could take between a thread becoming ready to run and the actual time at which that same thread starts to run). This delay is unacceptable for many modern computing devices, which need to make better and faster real-time guarantees that operations will complete time critical tasks in shorter guaranteed periods of time.

According to a first aspect of the present invention there is provided a method of switching contexts between threads in different user processes on a computing device in which those portions of the context switch which involve either modification of page directory entries or the flushing of a data cache are performed with pre-emption enabled, and in which for those portions the context switch is pre-empted by a kernel thread.

According to a second aspect of the present invention there is provided a computing device arranged to operate in accordance with a method of the first aspect

According to a third aspect of the present invention there is provided an operating system for causing a computing device to operate in accordance with a method of the first aspect

An embodiment of the invention will now be described, by way of further example only, with reference to the accompanying drawing, in which:—

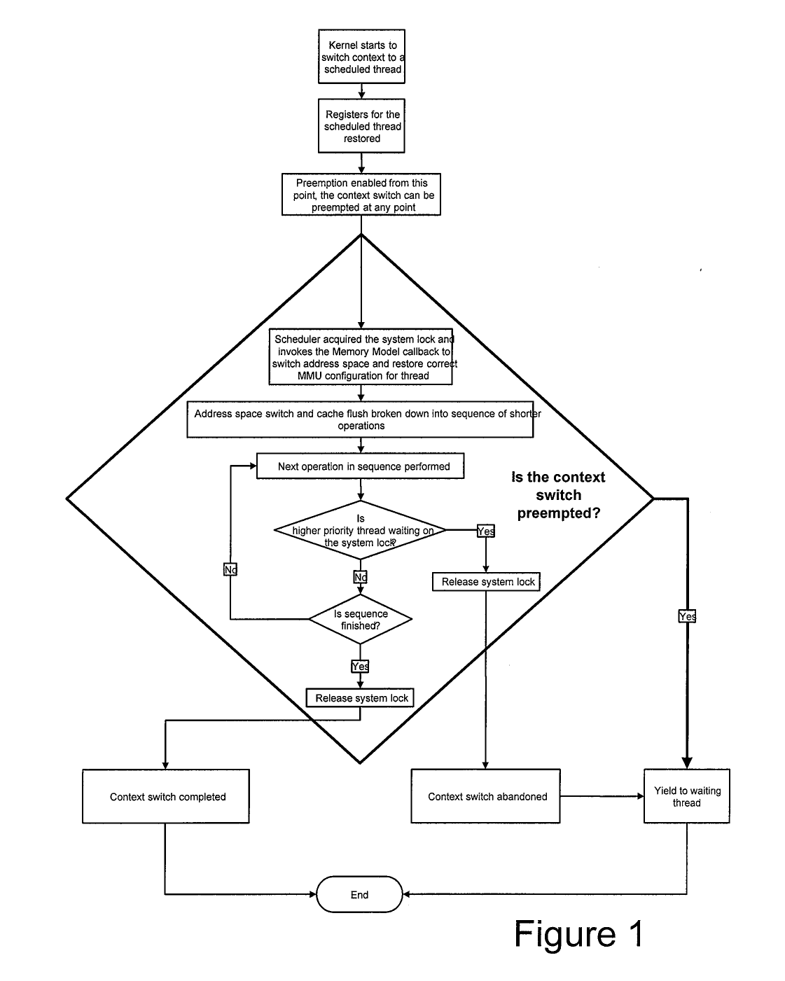

FIG. 1 shows an embodiment of preemptible context switching according to the present invention.

The perception behind this invention is that not all context switches from threads running in user processes require the full list of actions outlined above.

In particular, switches from threads in user processes to kernel threads (privileged threads running in supervisor mode) together with threads in certain fixed user processes (see below) can occur much faster and so should have lower guaranteed latency. To achieve this goal, this invention allows for the modification of page directory entries and the flushing of the data cache to take place with preemption enabled.

The following embodiment of the invention is described here relation to the Symbian OS operating system, the global open industry standard operating system for advanced, data-enabled mobile phones. It is assumed that the following explanation is readily understandable to those familiar with Symbian OS idioms.

The memory model provides the thread scheduler (part of the kernel) with a callback that should be used whenever an address space switch is required. The following description describes the sequence of events which occurs when the scheduler invokes that callback:
As stated earlier, because switching the user-mode address space is a complex operation, and can require a significant period of time, the address space switch is carried out with pre-emption enabled.
Essentially, the kernel restores the registers for the new thread, so that the system is using the new thread's supervisor stack, then re-enables preemption before restoring the correct MMU configuration. The new thread then establishes its own MMU configuration.
The user-mode address space is a shared data object in the kernel, because more than one thread may wish to access the user-mode memory of a different process; for example during inter process communication (IPC) or device driver data transfers. Clearly, re-enabling preemption requires some other means of protection in order to prevent multiple threads modifying the page directory entries simultaneously. This is provided by ensuring that code holds the system lock fast mutex while performing these operations. The operation of the system lock and the fast mutex are disclosed in Patent Application PCT/GB2005/001300.
This decision has a significant impact on kernel-side software, and the memory model in particular—the system lock must be held whenever another process's user-mode memory is being accessed to ensure a consistent view of user-mode memory.
The context switch is such a long operation that holding the system lock for the entire duration would have an impact on the real time behaviour of the OS as a whole, because kernel threads also need to acquire this lock to transfer data to and from user-mode memory.
With the present invention, this problem is addressed by regularly checking during the context switch to see if another thread is waiting on the system lock. If a waiting thread is found, it is assumed that the thread must be a kernel thread, because they are the only threads allowed to hold the system lock. Hence, in this case, the context switch is abandoned and the waiting thread is allowed to run.
This leaves the user-mode address space in a semi-consistent state: kernel software can locate and manipulate any user-mode chunk of address space as required, but when the user-mode thread is scheduled again, more action will be required to complete the address space switch.

A typical procedure is shown in FIG. 1. The procedure commences when the OS kernel starts to switch context to a scheduled thread. Registers for the scheduled thread are then restored, and preemption is enabled. When preemption has been enabled, the context switch can be preempted at any point.

The scheduler then acquires the system lock and invokes the memory module callback to switch address space and restore the correct MMU configuration for the thread. The address space switch and the cacheflush described above are broken down into a sequence of shorter operations, and these shorter operations are then carried out in turn. Therefore, as shown in FIG. 1, the next operation in the sequence is then performed. Then, it is determined whether a higher priority thread is waiting on the system lock. If the answer is no, the sequence of operations are continued, with a check being made for higher priority threads waiting on the system lock after each operation in the sequence, until the sequence is completed. Once the sequence is completed, the system lock is released and the context switch is completed.

If at any time during the performance of the sequence of operations it is determined that a higher priority thread is waiting on the system lock, the system lock is released, the context switch is abandoned at that time, and the system yields to the higher priority waiting thread. This procedure can be seen in FIG. 1.

It was mentioned above that threads in certain user processes are permitted to pre-empt context switches. The threads in question are those that are part of fixed processes. Both kernel threads and user threads belonging to user processes which use an MMU domain (known as fixed processes) can preempt the context switch at any point and run immediately. Threads belonging to other user processes can still preempt the context switch, but only at the points where contention for the system lock is checked for. The MMU tables must then be adjusted before the new thread can run. The advantage of fixed processes is that the data cache need not be flushed.

Only important and heavily used server processes are marked as fixed processes. What distinguishes them from normal user processes, and enables them to preempt a context switch, is that instead of allocating the data chunks for these processes in the normal data section for user processes, the OS memory model allocates them in the kernel section and they are never moved. If possible, the memory model also allocates an MMU domain to provide protection for the fixed process memory.

The result is that a context switch to or from a fixed process is similar to a switch to or from a kernel process and does not require any modifications of the page directory entries or a cache flush.

One consequence of using this feature is that only a single instance of a fixed process can ever run, but this is quite a reasonable constraint for most of the server processes in the OS. In this embodiment, typical processes that are marked as fixed are the file server, comms server, window server, font/bitmap server and database server. When this attribute is used effectively in a device, it makes a notable improvement to overall performance.

A fixed process optimisation relies on the memory model keeping track of several processes. It keeps a record of the following processes:

TheCurrentProcess: This is a kernel value that is really the owning process for the currently scheduled thread
TheCurrentVMProcess: This is the user-mode process that last ran. It ‘owns’ the user-mode memory map, and its memory is accessible.
TheCurrentDataSectionProcess: This is the user-mode process that has at least one moving chunk in the common address range—the data section.
TheCompleteDataSectionProcess: This is the user-mode process that has all of its moving chunks in the data section.

Note that some of these values may be NULL as a result of an abandoned context switch, or termination of the process. The algorithm used by the process context switch may be as follows:
1. If the new process is the kernel or has an MMU domain, skip all these steps.
2. If the new process is fixed, then go to step 7.
3. If the new process is not TheCompleteDataSectionProcess then flush the data cache as at least one chunk will have to be moved.
4. If a process other than the new one occupies the data section then move all of its chunks to the home section and protect them.
5. If a process other than the new one was the last user process then protect all of its chunks.
6. Move the new process's chunks to the data section (if not already present) and unprotect them. Go to step 9.
7. [Fixed process] Protect the chunks of The CurrentVMProcess.
8. Unprotect the chunks of the new process.
9. Flush the translation lookaside buffer (TLB) if any chunks were moved or permissions changed.

It can be appreciated from the above description that context switching between threads belonging to different user-side processes can be a time consuming procedure owing to the need to move a potentially large number of memory mappings around and to the need to flush the data cache on hardware architectures which utilize a virtually tagged data cache. This invention allows the modification of page directory entries and the flushing of the data cache during a context switch to occur with pre-emption enabled; if a third process needs to run during a context switch, and this third process doesn't own or require any user memory modification of the page tables, this is now possible. By means of this invention, switches to kernel threads and threads in fixed user processes can occur much faster; these threads don't belong to processes that own any user memory and are the very ones that need to run with a lower guaranteed latency to ensure real-time performance.

This invention provides, therefore, significant advantages over the known art by improving the real-time performance of an operating system by allowing a limited amount of preemption of context switches between user mode threads.

Although the present invention has been described with reference to particular embodiments, it will be appreciated that modifications may be effected whilst remaining within the scope of the present invention as defined by the appended claims.

1. A method of switching contexts between threads in different user processes on a computing device in which those portions of the context switch which involve either modification of page directory entries or the flushing of a data cache are performed with pre-emption enabled, and in which for those portions the context switch is pre-empted by a kernel thread.

2. A method according to claim 1 wherein the kernel thread holds a data object that can only be claimed by kernel threads, and in which the computing device checks during the context switch to see whether there are any threads waiting on the said object.

3. A method according to claim 2 wherein the data object is a mutex.

4. A method according to claim 1 wherein portions of the context switch are pre-empted by a user thread running in a process which has its memory allocated in that portion of memory normally reserved for use by an MMU domain and for the kernel.

5. A computing device arranged to operate in accordance with a method as claimed in claim 1.

6. An operating system for causing a computing device to operate in accordance with a method as claimed in claim 1.
